(19) United States
(12) Patent Application Publication
(10) Pub. No.: US 2023/0404187 A1
(43) Pub. Date: Dec. 21, 2023

(54) RUBBER THIMBLE AND MANUFACTURING METHOD THEREOF

(71) Applicant: JAEKYUNG MTS CO., LTD., Gumi-si, Gyeongsangbuk-do (KR)

(72) Inventor: Jae Bong KIM, Gumi-si (KR)

(73) Assignee: JAEKYUNG MTS CO., LTD., Gumi-si, Gyeongsangbuk-do (KR)

(21) Appl. No.: 18/036,158

(22) PCT Filed: Nov. 5, 2021
(86) PCT No.: PCT/KR2021/015980

§ 371 Date: May 9, 2023

(30) Foreign Application Priority Data
Nov. 10, 2020 (KR) 10-2020-0149145
Oct. 27, 2021 (KR) 10-2021-0144297

(51) Int. Cl. A41D 13/08; D05B 91/04

(52) U.S. Cl. CPC A41D 13/087; D05B 91/04

(57) ABSTRACT

A rubber thimble has a novel structure and prevents a user from feeling pressure from a reinforced ring formed on the upper peripheral part. The rubber thimble has a reinforced ring on the upper part of a thimble body to enable easy retrieval of the rubber thimble from a mold during the manufacture of the rubber thimble, as well as prevent the upper end of the thimble body, which is very thinly manufactured, from tearing easily, and enable the user to accomplish a basic function of wearing the rubber thimble on a finger or taking the rubber thimble off the finger by holding the reinforced ring. A plurality of weak parts formed on the reinforced ring reduces the elasticity and strength of the reinforced ring, thereby preventing the reinforced ring from applying a strong pressure to the user's finger and causing numbness or pain to the user's finger.

### TECHNICAL FIELD

The present disclosure relates to a rubber thimble with a new structure capable of preventing a user from feeling pressure by a reinforcing ring formed on an upper end circumference.

### BACKGROUND ART

In general, workers who manufacture precise electronic products are working with a rubber thimble on their fingers to protect the user's hands while preventing electronic products from being damaged by static electricity or from being contaminated by sweat or secretions on their hands.

As shown in FIGS. 1 and 2, such a rubber thimble has a thimble body 10 formed in a tubular shape extending vertically and having an open upper end and a closed lower end, and a reinforcing ring 20 formed around the upper end of the thimble body 10.

In this case, the lower end of the thimble body 10 is formed in a hemispherical shape protruding downward.

In addition, the reinforcing ring 20 is configured to have a circular cross-sectional shape.

As shown in FIG. 3, in manufacturing such a rubber thimble, a cylindrical mold 30 extending in the vertical direction is dipped into the liquid rubber 31 such that the liquid rubber 31 is applied to the circumference of the mold 30 to extend a little longer than the thimble body 10. When the liquid rubber 31 is properly semi-dried, the upper end of the applied liquid rubber 31 may be rolled downward to form the reinforcing ring 20, as shown in FIG. 4. Then, the liquid rubber may be dried using a dryer to form a rubber thimble. By peeling off the finished rubber thimble from the mold 30, the manufacture of the rubber thimble may be completed.

When peeling off the rubber thimble from the mold 30, it is common to roll the reinforcing ring 20 downward such that the rubber thimble body 10 is wound around the reinforcing ring 20, and thus the rubber thimble can be smoothly peeled from the mold 30.

In addition, such a rubber thimble is configured to be a little smaller than the figure size of an average user. Thus, the thimble body 10 is configured to closely contact the user's finger when the rubber thimble is fit onto the finger.

In this regard, the reinforcing ring 20 reinforces the upper end of the thimble body 10, allowing the rubber thimble to be easily taken out of the mold 30 in manufacturing the rubber thimble, while preventing the top of the thimble body 10, which is very thin, from being easily torn, and allowing the user to fit the rubber thimble onto the finger or remove the rubber thimble from the figure.

However, the reinforcing ring 20 has high elasticity and strength due to the thimble body 10. Accordingly, when the rubber thimble is fit into the finger, the reinforcing ring 20 is likely to strongly press the circumference of the finger, resulting in numbness or pain on the user's finger.

Therefore, there is a need for a new method to address the aforementioned issue.

### DISCLOSURE

### Technical Problem

Therefore, the present disclosure has been made in view of the above problems, and it is one object of the present disclosure to provide a rubber thimble of a new structure configured to prevent a user from feeling pressed by a reinforcing ring formed on an upper circumference thereof.

### Technical Solution

In accordance with one aspect of the present disclosure, provided herein is a rubber thimble including a thimble body in a vertical direction and having an open upper end and a closed lower end, and a reinforcing ring 20 formed around the upper end of the thimble body 10, the rubber thimble including a vulnerable part 21 concavely formed on an outer circumferential surface of the reinforcing ring 20.

According to another embodiment, the vulnerable part 21 comprises a plurality of vulnerable parts formed on the outer circumferential surface of the reinforcing ring 20 to be spaced apart from each other.

According to another embodiment, a perforated line 11 is formed on an upper end circumference of the thimble body 10, such that, when the reinforcing ring 20 is pulled, the reinforcing ring 20 is separated and removed from the thimble body 10 by the vulnerable part 21 and the perforated line 11.

According to another embodiment, the thimble body 10 has a discharge hole 12 formed to pass through inner and outer surfaces thereof.

In accordance with another aspect of the present disclosure, provided herein is a method of manufacturing the rubber thimble, the method including dipping the cylindrical mold 30 extending in the vertical direction into the liquid rubber 31 such that the liquid rubber 31 is applied to a circumference of the mold 30, when the liquid rubber 31 is properly semi-dried, forming the reinforcing ring 20 by rolling the upper end of the applied liquid rubber 31 downward, and drying the liquid rubber using a dryer, wherein the vulnerable part 21 is formed by pressing an outer circumferential surface of the reinforcing ring 20 using a molding member 40 after forming the reinforcing ring 20 by rolling the upper end of the liquid rubber 31.

In accordance with another aspect of the present disclosure, provided herein is a method of manufacturing the rubber thimble, the method including dipping the cylindrical mold 30 extending in the vertical direction into the liquid rubber 31 such that the liquid rubber 31 is applied to a circumference of the mold 30, when the liquid rubber 31 is properly semi-dried, forming the reinforcing ring 20 using a peeling member 50 provided to the mold 30, and forming the vulnerable part 31 on the circumference of the reinforcing ring 20, wherein the peeling member 50 includes a lifting ring 51 coupled to an outside of the mold 30 so as to be liftable, and a plurality of extension bars 52 extending downward from the lifting ring 51, wherein the peeling member is moved up and down by a lifting driving means 53.

In accordance with another aspect of the present disclosure, provided herein is a method of manufacturing the rubber thimble, the method including dipping the cylindrical mold 30 extending in the vertical direction into a hard liquid rubber 33 and drying the same, dipping the mold 30 into a soft liquid rubber 35, when the liquid rubber 31 is properly semi-dried, forming the reinforcing ring 20 by rolling an upper end of the applied soft liquid rubber 35 downward, and drying the liquid rubber using a dryer, wherein a depth of the dipping into the hard liquid rubber 33 is formed to be 30% to 90% of a height of the thimble body 10.

In the manufacturing method according to the embodiments of the present disclosure, the protrusion 35 and/or the coding part 36 with the non-adhesive coating may be further formed on the outside of the mold 30 at positions corresponding to the perforated line 11, the discharge hole 12, and the vulnerable part 21. Thus, various official parts may be formed in manufacturing the rubber thimble.

### Advantageous Effects

According to the present disclosure, a rubber thimble has a reinforcing ring 20 on an upper side of the thimble body 10, which may allow the rubber thimble to be easily removed from the mold 30 when manufacturing the rubber thimble, and prevent the upper end of the thimble body 10, which is manufactured very thin, from being easily torn. In addition, the rubber thimble may allow the user to faithfully perform the basic function of holding the reinforcing ring 20 and fitting the rubber thimble onto the finger or removing the rubber thimble from the finger. Further, since a plurality of vulnerable parts 21 is formed on the reinforcing ring 20 to lower the elasticity and strength of the reinforcing ring 20, the reinforcing ring 20 may be prevented from strongly pressing the user's finger to cause numbness or pain to the user's finger.

### DESCRIPTION OF DRAWINGS

FIG. 1 is a side cross-sectional view illustrating a conventional rubber thimble;

FIG. 2 is a plan view illustrating the conventional rubber thimble;

FIGS. 3 and 4 are reference diagrams illustrating a method of manufacturing the conventional rubber thimble;

FIG. 5 is a side cross-sectional view illustrating a rubber thimble according to the present disclosure;

FIG. 6 is a plan view illustrating the rubber thimble according to the present disclosure;

FIGS. 7 to 9 are reference diagrams illustrating a method of manufacturing the rubber thimble according to the present disclosure;

FIGS. 10 to 12 are reference diagrams illustrating a modified example of the method of manufacturing the rubber thimble according to the present disclosure;

FIG. 13 is a front view illustrating a second embodiment of the rubber thimble according to the present disclosure;

FIG. 14 is a plan view illustrating the second embodiment of the rubber thimble according to the present disclosure;

FIG. 15 is a front view illustrating the operation of the second embodiment of the rubber thimble according to the present disclosure;

FIG. 16 is a front view illustrating a third embodiment of the rubber thimble according to the present disclosure;

FIG. 17 is a side cross-sectional view illustrating the third embodiment of the rubber thimble according to the present disclosure;

FIG. 18 is a front view illustrating a fourth embodiment of the rubber thimble according to the present disclosure;

FIG. 19 is a side cross-sectional view illustrating the fourth embodiment of the rubber thimble according to the present disclosure;

FIG. 20 is a front view and a cross-sectional view illustrating embodiments of a protrusion according to the present disclosure; and

FIG. 21 is a front view illustrating embodiments of a coating part according to the present disclosure.

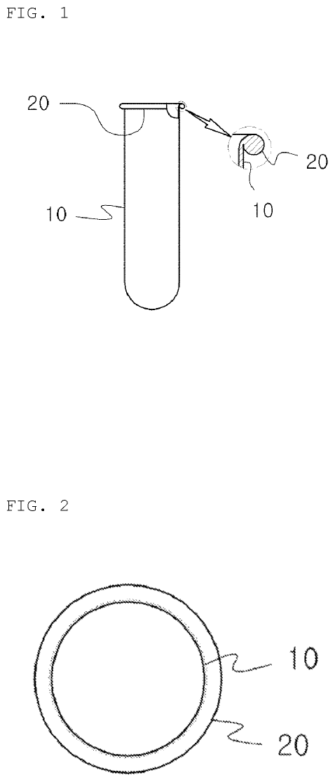

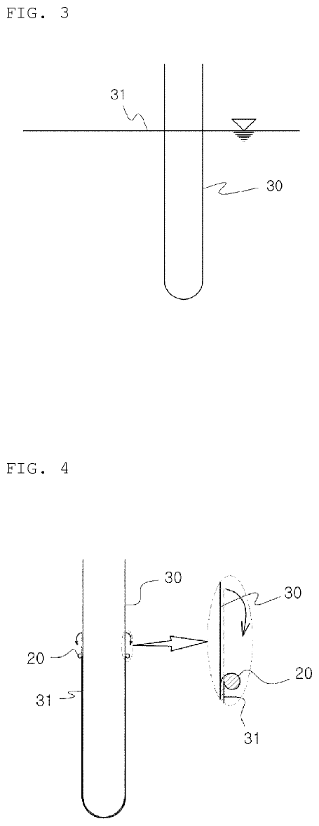

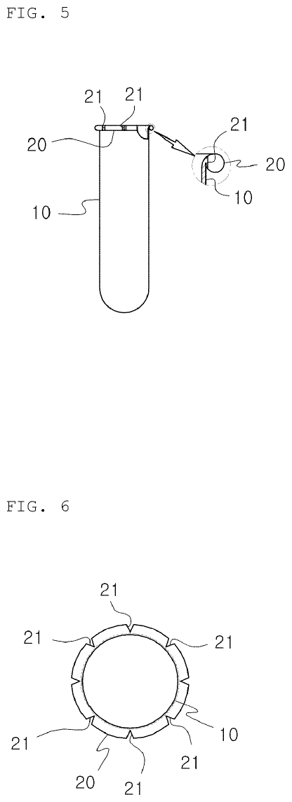

### LIST OF REFERENCE NUMERALS

10: Thimble body 20: Reinforcing ring
20′: Reinforcing ring formation position 21: Vulnerable part
21″: Vulnerable part formation position 30: Mold
40: Molding member

### BEST MODE

Hereinafter, the present disclosure will be described in detail with reference to the accompanying exemplary drawings.

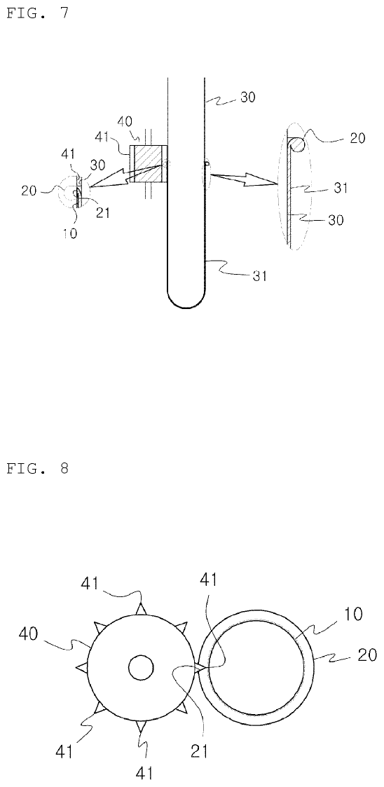

FIGS. 5 and 6 illustrate a rubber thimble according to the present disclosure. Like the conventional rubber thimble, the rubber thimble includes a thimble body 10 formed in a tubular shape extending in a vertical direction and having an open upper end and a closed lower end, and a reinforcing ring 20 formed around the upper end of the thimble body 10.

Accordingly, a cylindrical mold 30 extending in the vertical direction is dipped into the liquid rubber 31 such that the liquid rubber 31 is applied to the circumference of the mold 30 to extend a little longer than the thimble body 10. When the liquid rubber 31 is properly semi-dried, the upper end of the applied liquid rubber 31 may be rolled downward to form the reinforcing ring 20. Then, the liquid rubber may be dried using a dryer to form a rubber thimble. By peeling off the finished rubber thimble from the mold 30, the manufacture of the rubber thimble may be completed.

In addition, according to the present disclosure, a vulnerable part 21 is formed concave on the outer circumferential surface of the reinforcing ring 20.

The vulnerable part 21 includes multiple vulnerable parts formed on the outer circumferential surface of the reinforcing ring 20 and spaced apart from each other at regular intervals. At the positions where the vulnerable part 21, the reinforcing ring 20 has a reduced thickness and thus has lowered elasticity and strength.

In the process of manufacturing the rubber thimble, after the reinforcing ring 20 is formed by rolling the top of the liquid rubber 31, and then the vulnerable part 21 is formed by pressing the outer circumferential surface of the reinforcing ring 20 using a molding member 40 before heating the liquid rubber 31 with a dryer, as shown in FIGS. 7 to 9.

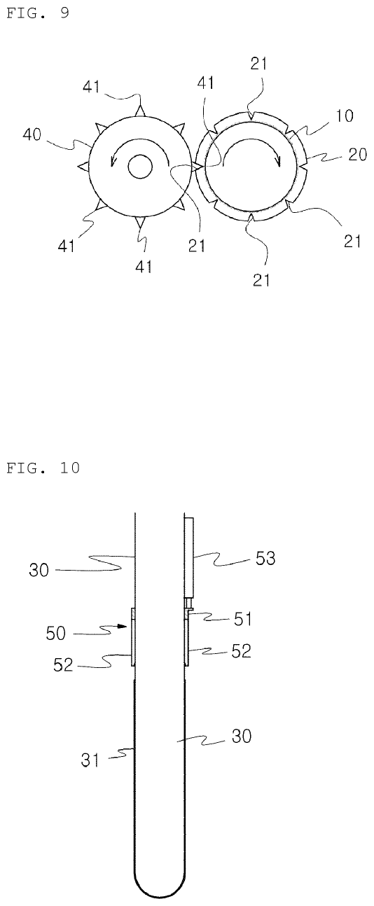

To this end, the mold 30 is configured to rotate laterally on the circumferential surface. The molding member 40 is formed in a circular rod shape and provided with molding protrusions 41 corresponding to the shape of the vulnerable part 21 and formed on the circumferential surface thereof to be spaced apart at regular intervals, and is configured to rotate in the opposite direction to the mold 30. Thus, the vulnerable parts 21 are formed on the circumferential surface of the reinforcing ring 20 at regular intervals by rotating the mold 30 and the molding member 40 in opposite directions as shown in FIG. 9 while the molding member 40 is disposed such that the molding protrusions 41 press the circumferential surface of the reinforcing ring 20 as shown in FIGS. 7 and 8.

The structure of the rubber thimble may be equipped with the reinforcing ring 20 on the upper side of the thimble body 10. Accordingly, the rubber thimble may be easily taken out of the mold 30 in manufacturing the rubber thimble, and the top of the thimble body 10, which is very thin, may not be easily torn. In addition, the rubber thimble may allow the user to faithfully perform the basic function of holding the reinforcing ring 20 and fitting the rubber thimble onto the finger or removing the rubber thimble from the finger. Further, since a plurality of vulnerable parts 21 is formed on the reinforcing ring 20 to lower the elasticity and strength of the reinforcing ring 20, the reinforcing ring 20 may be prevented from strongly pressing the user's finger to cause numbness or pain to the user's finger

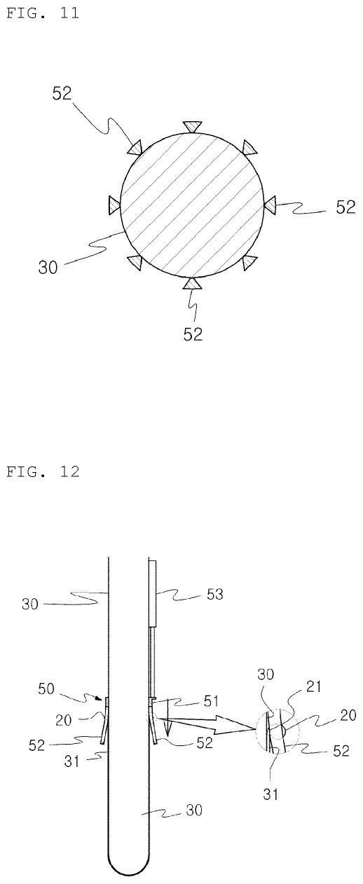

In addition, in this embodiment, the vulnerable part 21 is formed by rolling the top of the liquid rubber 31 to form a reinforcing ring 20 and then pressing the outer circumferential surface of the reinforcing ring 20 using the molding member 40 in the process of manufacturing the rubber thimble. Alternatively, as shown in FIGS. 10 to 12, the reinforcing ring 20 may be formed using a peeling member 50 forming the reinforcing ring 20, while the vulnerable part 31 is formed on the circumference of the reinforcing ring 20.

In detail, the peeling member 50 includes a lifting ring 51 coupled to the outside of the mold 30 so as to be liftable, and a plurality of extension bars 52 extending downward from the lifting ring 51, and is moved and down by a lifting driving means 53.

Here, the extension bars 52 are made of an elastic material, and are composed of eight extension bars provided to the lifting ring 51 and spaced apart from each other at regular intervals as shown in FIG. 11. The inner surface of each extension bar 52, that is, the surface on the side facing the mold 30, is configured to correspond to the shape of the vulnerable part 31.

The lifting driving means 53 is provided to the mold 30 and is connected to the lifting ring 51 of the peeling member 50. It employs a cylinder mechanism that lifts and lows the peeling member 50 by expansion and contraction.

Therefore, as shown in FIG. 10, when the peeling member 50 remains lifted, the mold 30 is dipped into the liquid rubber 31 such that the liquid rubber 31 is applied to the circumference of the mold 30. When the liquid rubber 31 is properly semi-dried, the lifting means 53 is controlled to lower the peeling member 50.

At this time, the extension bars 52 push the upper end of the liquid rubber 31 downward to make the upper end of the liquid rubber 31 rolled in a ring shape to form the reinforcing ring 20, while the inner surfaces of the extension bars 52 presses the outer surface of the reinforcing ring 20 inward to form the vulnerable parts 31.

As described above, various modifications may be made to the method of forming the vulnerable part 31 in the reinforcing ring 30.

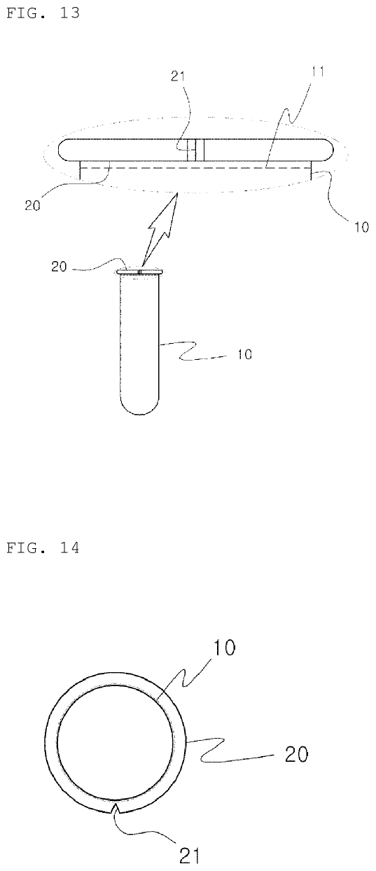

In another embodiment of the present disclosure illustrated in FIGS. 13 to 15, the vulnerable part 21 is formed concave only in one place on the outer circumferential surface of the reinforcing ring 20.

In addition, a perforated line 11 is formed on the circumference of the upper end of thimble body 10.

The perforated line 11 is composed of multiple slits formed in a row on the circumference of the upper end of the thimble body 10 by penetrating the inner and outer side surfaces of the thimble body 10 such that the slits are arranged close to the lower side of the reinforcing ring 20.

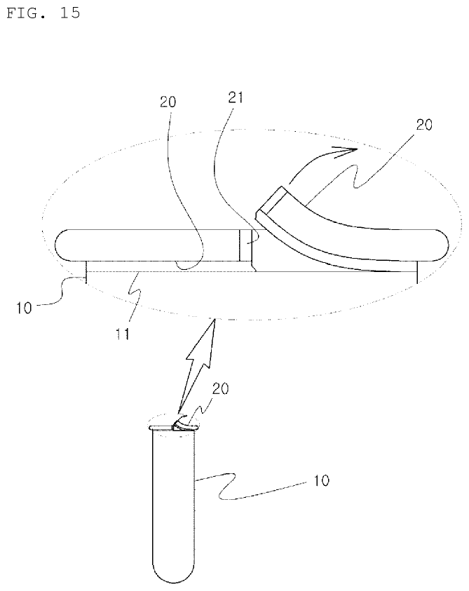

When the user having the above-described rubber thimble fitted onto his or her finger pulls one side of the reinforcing ring 20 outward strongly by hand, one side of the reinforcing ring 20 is cut by the vulnerable part 21, and the reinforcing ring 20 is separated from the thimble body 10 as the perforated line 11 is cut off, as shown in FIG. 15.

Accordingly, the user may simply cut and remove the reinforcing ring 20 without a separate tool after fitting the rubber thimble onto the finger. Therefore, the finger may be more effectively protected from pain by the reinforcing ring 20.

While it is described in this embodiment that only one vulnerable part 21 is formed, multiple vulnerable parts 21 may be formed to allow the user to selectively cut and remove only a portion of the reinforcing ring 20.

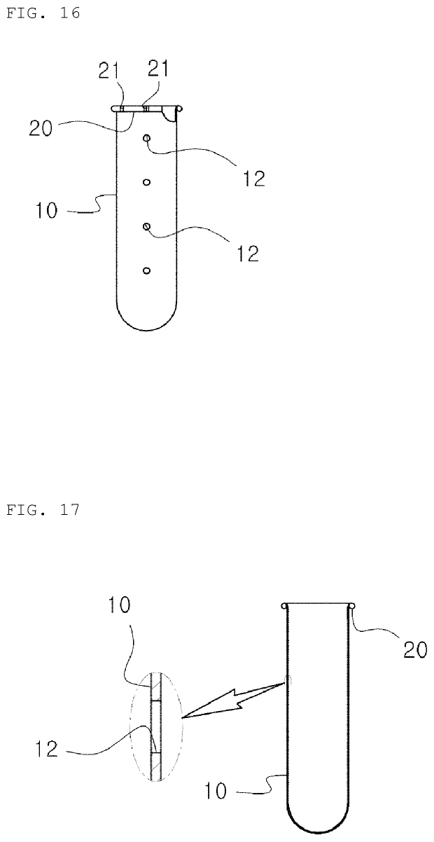

FIGS. 16 and 17 illustrate a third embodiment of the present disclosure. As in the first embodiment, multiple vulnerable parts 21 are formed in the reinforcing ring 20 to prevent the reinforcing ring 20 from causing pain to the finger.

In addition, a discharge hole 12 is formed in the thimble body 10 such that the inner and outer side surfaces communicate with each other therethrough.

A plurality of discharge holes 12 is formed to be spaced apart from each other at regular intervals along the longitudinal direction of the thimble body 10.

When sweat is generated from the finger of the user onto which the user has fitted the rubber thimble, the rubber thimble configured as described above allow sweat to be discharged to the outside through the discharge hole 12 such that the inside of the rubber thimble remains dry.

Therefore, when the user has the rubber thimble fitted onto the finger, the inside of the rubber thimble may be prevented from becoming unsanitary due to sweat, and may be kept pleasant.

It is illustrated in this embodiment that multiple vulnerable parts 21 are formed in the reinforcing ring 20. However, as in the second embodiment, the vulnerable part 21 may be formed concave only in one place on the outer circumference of the reinforcing ring 20, and the perforated 11 may be formed on the circumference of the upper end of the thimble body 10.

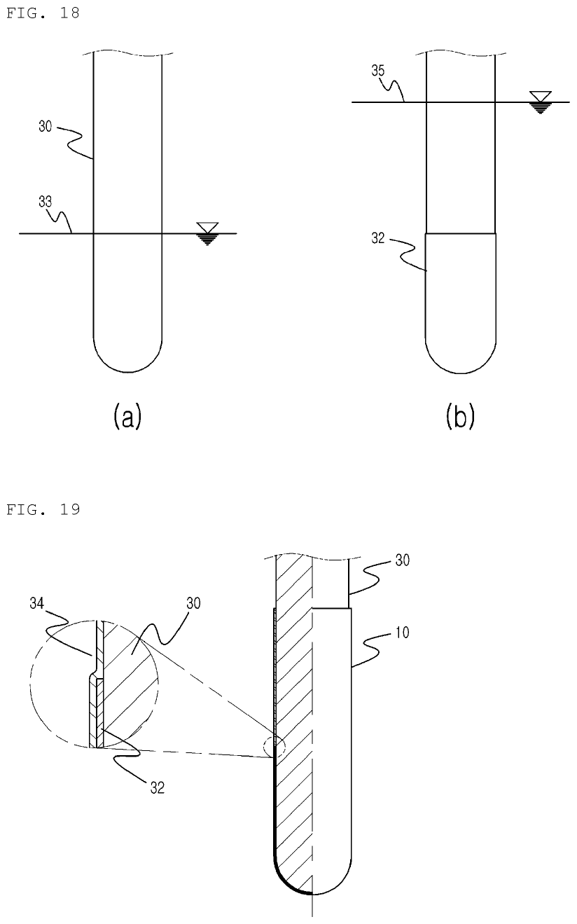

FIGS. 18 and 19 illustrate a fourth embodiment of the present disclosure. The fourth embodiment has the same shape as a general rubber thimble, but the inside of the thimble body 10 is formed of hard rubber 32, and the outside thereof is formed of soft rubber 34.

To this end, the mold 30 is dipped into hard liquid rubber 33 as shown in FIG. 18-(a), dried, and then dipped into soft liquid rubber 35 as shown in FIG. 18-(b), such that the hard rubber 33 is applied to the circumference of the mold 32.

The depth of dipping of the mold 30 into the hard liquid rubber 33 is not limited. However, dipping the mold 30 deeply into the hard liquid rubber 33 may increase the thickness of the reinforcing ring 20 to increase pressure applied to the finger, and may increase hardness of the thimble body 10 to make it difficult to put on and remove the thimble.

In addition, since the hard rubber 32 also includes the purpose of stably fitting the rubber thimble onto the finger, the depth of dipping of the mold 30 into the hard liquid rubber 33 may be set to 30 to 90% of the height of the thimble body 10.

According to the fourth embodiment, when the rubber thimble is put on, stability may be increased and pressure from the reinforcing ring 20 may be reduced. Also, when the perforated line 11 is additionally configured on the upper circumference of the thimble body 10, sufficient wearability may be secured due to hard rubber even if the reinforcing ring 20 is removed.

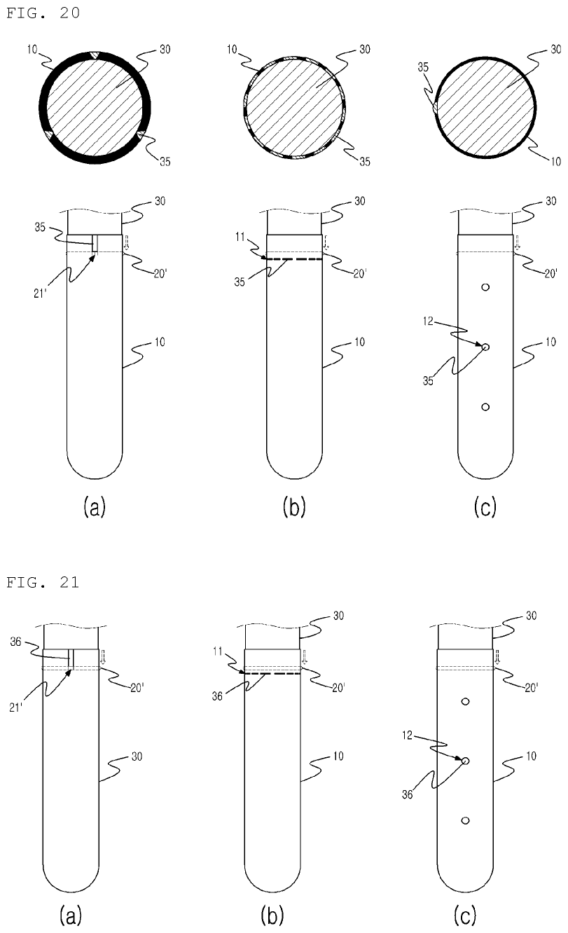

FIG. 20 illustrates a protrusion 35 configured in the mold 30 according to the present disclosure. The protrusion 35 with a non-adhesive coating may be formed outside the mold 30 at the positions where the perforated line 11, the discharge hole 12, and the vulnerable part 21, which are the features of the present disclosure, are configured.

Alternatively, as shown in FIG. 21, a coating part 36 with a non-adhesive coating may be formed to obtain the same effect as the protrusion 35. The non-adhesive coating part 36 may be further formed on the protrusion 35. The non-adhesive coating generally refers to a Teflon coating using a fluorine resin, which is widely known, but may include all other non-adhesive coating methods known in the art.

The manufacturing process of the thimble body 10 including the main components of each embodiment may be further simplified according to the protrusion 35 and the coating part 36 formed on the mold 30 to increase production efficiency. In the present disclosure, only the perforated line 11, the discharge hole 12, and the vulnerable part 21 are mentioned. However, embodiments are not limited thereto, and various well-known forms may be provided.

Hereinafter, a method of manufacturing a rubber thimble according to the present disclosure will be described.

The rubber thimble may be manufactured in a manner that a cylindrical mold 30 extending in a vertical direction is dipped into the liquid rubber 31 such that the liquid rubber 31 is applied to the circumference of the mold 30 to extend a little longer than the thimble body 10, the upper end of the applied liquid rubber 31 is rolled downward to form the reinforcing ring 20 when the liquid rubber 31 is properly semi-dried, and then the liquid rubber is dried using a dryer (Method S1), or in a manner that the mold 30 is dipped into the hard liquid rubber 33 and dried and is then dipped again into the soft liquid rubber 35, the upper end of the applied soft liquid rubber 35 is rolled downward to form the reinforcing ring 20 when the soft liquid rubber 35 is properly semi-dried, and then the liquid rubber is dried using a dryer (Method S2).

One or more vulnerable parts 31 may be formed in the rubber thimble, and the perforated line 11 and the discharge hole 12 may be further configured to allow the reinforcing ring 20 to be cut off.

To physically form the vulnerable parts 31, after the reinforcing ring 20 is formed according to Methods S1 and S2, the outer circumferential surface of the reinforcing ring 20 may be pressed using the molding member 40. Alternatively, the reinforcing ring 20 and the vulnerable parts 31 may be formed together using the peeling member 50, which includes a lifting ring 51 coupled to the outside of the mold 30 so as to be liftable extension bars 52 and a plurality of extension bars 52 extending downward from the lifting ring 51, and is lifted by the lifting driving means 53.

To chemically the vulnerable parts 31, at least one of the protrusion 35 with a non-adhesive coating and the coating part 36 with a non-adhesive coating may be provided on the outside of the mold 30. Then, when manufacturing a rubber thimble according to Methods S1 and S2, the vulnerable parts 31 may be formed because the liquid rubber 31, the hard liquid rubber 33, and the soft liquid rubber 35 are not adhered to the protrusion 35 and the coating part 36. In addition, the protrusion 35 may further include the coating part 36.

To physically form the perforated line 11 and the discharge hole 12, methods widely known in the art, such as perforation and cutting, may be used. To chemically form the perforated line 11 and the discharge hole 12, the same method as the chemical formation method for the vulnerable parts 31 may be used.

1. A rubber thimble comprising:
a thimble body in a vertical direction and having an open upper end and a closed lower end,
a reinforcing ring formed around the upper end of the thimble body, and
a vulnerable part formed on an outer circumferential surface of the reinforcing ring.

2. The rubber thimble of claim 1, wherein the vulnerable part comprises one or more vulnerable parts formed on the outer circumferential surface of the reinforcing ring to be spaced apart from each other.

3. The method of claim 1, wherein a perforated line is formed on an upper end circumference of the thimble body, such that, when the reinforcing ring is pulled, the reinforcing ring is separated and removed from the thimble body by the vulnerable part and the perforated line.

4. The rubber thimble of claim 1, wherein the thimble body has a discharge hole formed to pass through inner and outer surfaces thereof.

5. The rubber thimble of claim 1, further comprising:
a protrusion with a non-adhesive coating formed on an outside of the mold at positions corresponding to the perforated line, the discharge hole, and the vulnerable part.

6. The rubber thimble of claim 1, further comprising:
a coating part with a non-adhesive coating formed on the outside of the mold and the protrusion.

7. A method of manufacturing the rubber thimble of claim 1, the method comprising:
dipping the cylindrical mold extending in the vertical direction into the liquid rubber such that the liquid rubber is applied to a circumference of the mold;
when the liquid rubber is properly semi-dried, forming the reinforcing ring by rolling the upper end of the applied liquid rubber downward; and
drying the liquid rubber using a dryer,
wherein the vulnerable part is formed by pressing an outer circumferential surface of the reinforcing ring using a molding member after forming the reinforcing ring by rolling the upper end of the liquid rubber.

8. A method of manufacturing the rubber thimble of claim 1, the method comprising:
dipping the cylindrical mold extending in the vertical direction into the liquid rubber such that the liquid rubber is applied to a circumference of the mold;
when the liquid rubber is properly semi-dried, forming the reinforcing ring using a peeling member provided to the mold; and
forming the vulnerable part on the circumference of the reinforcing ring (20),
wherein:
the peeling member comprises:
a lifting ring coupled to an outside of the mold so as to be liftable; and
a plurality of extension bars extending downward from the lifting ring, and
the peeling member is moved up and down by a lifting driving means.

9. A method of manufacturing the rubber thimble of claim 1, the method comprising:
dipping the cylindrical mold extending in the vertical direction into a hard liquid rubber and drying the same;
dipping the mold into a soft liquid rubber,
when the liquid rubber is properly semi-dried, forming the reinforcing ring by rolling an upper end of the applied soft liquid rubber downward; and
drying the liquid rubber using a dryer,
wherein a depth of the dipping into the hard liquid rubber is formed to be 30% to 90% of a height of the thimble body.

10. The method of claim 7, wherein the protrusion with the non-adhesive coating is further formed on the outside of the mold at positions corresponding to the perforated line, the discharge hole, and the vulnerable part.

11. The method of claim 7, wherein the coating part with the non-adhesive coating is further formed on the outside of the mold.

12. The rubber thimble of claim 2, further comprising:
a protrusion with a non-adhesive coating formed on an outside of the mold at positions corresponding to the perforated line, the discharge hole, and the vulnerable part.

13. The rubber thimble of claim 3, further comprising:
a protrusion with a non-adhesive coating formed on an outside of the mold at positions corresponding to the perforated line, the discharge hole, and the vulnerable part.

14. The rubber thimble of claim 4, further comprising:
a protrusion with a non-adhesive coating formed on an outside of the mold at positions corresponding to the perforated line, the discharge hole, and the vulnerable part.

15. The rubber thimble of claim 2, further comprising:
a coating part with a non-adhesive coating formed on the outside of the mold and the protrusion.

16. The rubber thimble of claim 3, further comprising:
a coating part with a non-adhesive coating formed on the outside of the mold and the protrusion.

17. The rubber thimble of claim 4, further comprising:
a coating part with a non-adhesive coating formed on the outside of the mold and the protrusion.

18. The rubber thimble of claim 5, further comprising:
a coating part with a non-adhesive coating formed on the outside of the mold and the protrusion.

19. The method of claim 8, wherein the protrusion with the non-adhesive coating is further formed on the outside of the mold at positions corresponding to the perforated line, the discharge hole, and the vulnerable part.

20. The method of claim 8, wherein the coating part with the non-adhesive coating is further formed on the outside of the mold.
